(19) United States
(12) Patent Application Publication
(10) Pub. No.: US 2025/0005946 A1
(43) Pub. Date: Jan. 2, 2025

(54) Handwriting Recognition Method, Training Method and Training Device of Handwriting Recognition Model

(71) Applicant: BOE Technology Group Co., Ltd., Beijing (CN)

(72) Inventor: Ruijiao SHI, Beijing (CN)

(21) Appl. No.: 18/292,942

(22) PCT Filed: Nov. 16, 2022
(86) PCT No.: PCT/CN2022/132268

§ 371 Date: Jan. 29, 2024

(51) Int. Cl. G06V 30/19; G06V 10/82; G06V 30/18; G06V 30/22; G06V 30/244; G06V 30/26

(52) U.S. Cl. CPC G06V 30/19147; G06V 10/82; G06V 30/18; G06V 30/19127; G06V 30/1916; G06V 30/19167; G06V 30/19173; G06V 30/22; G06V 30/244; G06V 30/26

(57) ABSTRACT

A handwriting recognition method including: determining an input text image according to a written text trace to be recognized; inputting the input text image into a handwriting recognition model to obtain prediction results of different spatial positions in the input text image. The handwriting recognition model includes an image feature extraction layer, a full connection layer and a Softmax layer, the image feature extraction layer is used for extracting a feature map of the input text image, the full connection layer is used for adjusting the number of the channels of the feature map to the number of characters supported by the handwriting recognition model, and the Softmax layer is used for obtaining the prediction probability values of the written text at different spatial positions; performing a multi-neighborhood merging on the prediction results of different spatial positions to obtain a recognition result.

### CROSS-REFERENCE TO RELATED APPLICATIONS

The present application is a U.S. National Phase Entry of International Application PCT/CN2022/132268 having an international filing date of Nov. 16, 2022, and entitled “Handwriting Recognition Method, Training Method and Training Device of Handwriting Recognition Model”, the contents of which should be regarded as being incorporated herein by reference.

### TECHNICAL FIELD

Embodiments of the disclosure are related to, but not limited to, the technical field of artificial intelligence, in particular to a handwriting recognition method, a training method and a training device of a handwriting recognition model.

### BACKGROUND

At present, handwriting recognition for full text is mostly realized by two stages, i.e., text detection and recognition. First, a text trace to be recognized is sent to a detection network to obtain position information of text, and then the position information is sent to a recognition network for text recognition. Overall recognition performance is largely limited by detection performance of the detector, which requires performing data labeling and model training for detection and recognition separately, with a tedious implementation process.

In related technologies, an end-to-end multi-line recognition network is proposed, which consists of two stages: encoding and decoding. In the encoding stage, a first feature vector is extracted by residual network, and a second feature vector is extracted by a bidirectional Long Short-Term Memory (LSTM) network and an encoder based on attention mechanism. In the decoding stage, row decoding and column decoding are carried out in two branches, and then a recognition result is output. However, the multi-line recognition network has a complex structure.

### SUMMARY

The following is a summary of subject matter described herein in detail. The summary is not intended to limit the protection scope of claims.

An embodiment of the disclosure provides a handwriting recognition method, which includes the following steps:
determining an input text image according to a written text trace to be recognized;
inputting the input text image into a handwriting recognition model to obtain prediction results of different spatial positions in the input text image, wherein the handwriting recognition model includes an image feature extraction layer, a full connection layer and a Softmax layer, the image feature extraction layer is configured to extract a feature map of the input text image, the full connection layer is configured to adjust a channel number of the feature map to a quantity of characters supported by the handwriting recognition model, and the Softmax layer is configured to obtain prediction probability values of a written text at the different spatial positions, each spatial position includes a width of at least one pixel*a height of at least one pixel; and
performing a multi-neighborhood merging on the prediction results of the different spatial positions to obtain a recognition result.

An embodiment of the present disclosure further provides a handwriting recognition device, including a memory and a processor connected to the memory, the memory is configured to store instructions, the processor is configured to perform steps of a handwriting recognition method according to any embodiment of the present disclosure based on the instructions stored in the memory.

An embodiment of the present disclosure further provides a computer readable storage medium on which a computer program is stored, and when the program is executed by the processor, the handwriting recognition method according to any embodiment of the present disclosure is implemented.

An embodiment of the disclosure further provides a training method of a handwriting recognition model, which includes the following steps:
constructing a training model of the handwriting recognition model, wherein the handwriting recognition model includes an image feature extraction layer, a full connection layer and a Softmax layer, the training model includes the handwriting recognition model and a height compression module, wherein the image feature extraction layer is configured to extract a feature map of the input text image, the full connection layer is configured to adjust a channel number of the feature map to a quantity of characters supported by the handwriting recognition model, the Softmax layer is configured to obtain prediction probability values of the written text at different spatial positions, and the height compression module is disposed between the image feature extraction layer and the full connection layer for compressing a height of the feature map extracted by the image feature extraction layer;
acquiring a plurality of sample text images, wherein a number of lines of written text in a sample text image is 1 line, and a height of the sample text image is a pixel, and a is a natural number greater than or equal to 1;
training the training model by using the plurality of sample text images according to a predefined loss function; and
removing the height compression module in the trained training model to obtain a trained handwriting recognition model.

An embodiment of the present disclosure further provides a training device of a handwriting recognition model, including a memory and a processor connected to the memory, wherein the memory is configured to store instructions, the processor is configured to execute steps of the training method of the handwriting recognition model according to any embodiment of the present disclosure based on the instructions stored in the memory.

An embodiment of the present disclosure further provides a computer-readable storage medium on which a computer program is stored, when the program is executed by a processor, the training method of the handwriting recognition model according to any embodiment of the present disclosure is implemented.

Other aspects may be comprehended upon reading and understanding of the drawings and detailed description.

### BRIEF DESCRIPTION OF DRAWINGS

Accompanying drawings are used for providing further understanding of technical solutions of the present disclosure, constitute a part of the specification, and are used for explaining the technical solutions of the present disclosure together with the embodiments of the present disclosure, but do not constitute limitations on the technical solutions of the present disclosure. Shapes and sizes of various components in the drawings do not reflect actual scales, but are only intended to schematically illustrate contents of the present disclosure.

FIG. 1 is a schematic flow diagram of a handwriting recognition method according to an exemplary embodiment of the present disclosure.

FIGS. 2A and 2B are schematic diagrams of two written text traces to be recognized according to an exemplary embodiment of the present disclosure.

FIG. 3 is a schematic structural diagram of a handwriting recognition model according to an exemplary embodiment of the present disclosure.

FIG. 4 is a schematic flow diagram of a recognition result post-processing according to an exemplary embodiment of the present disclosure.

FIG. 5 is a schematic diagram of a state transition matrix created during a word correction process according to an exemplary embodiment of the present disclosure.

FIG. 6 is a schematic flow diagram of a training method of a handwriting recognition model according to an exemplary embodiment of the present disclosure.

FIG. 7 is a schematic structural diagram of a training model of a handwriting recognition model according to an exemplary embodiment of the present disclosure.

FIG. 8 is a schematic diagram of a knowledge distillation process according to an exemplary embodiment of the present disclosure.

FIGS. 9A, 9B, and 9C are schematic diagrams of three types of recognition results according to an exemplary embodiment of the present disclosure.

FIG. 10 is a schematic structural diagram of a handwriting recognition device according to an exemplary embodiment of the present disclosure.

FIG. 11 is a schematic structural diagram of a device for training a handwriting recognition model according to an exemplary embodiment of the present disclosure.

### DETAILED DESCRIPTION

To make objectives, technical solutions, and advantages of the present disclosure clearer, the embodiments of the present disclosure will be described in detail with reference to the accompanying drawings. It is to be noted that the embodiments in the present disclosure and features in the embodiments may be randomly combined with each other if there is no conflict.

Unless otherwise defined, technical terms or scientific terms publicly used in the embodiments of the present disclosure should have usual meanings understood by those of ordinary skills in the art to which the present disclosure pertains. “First”, “second”, and similar terms used in the embodiments of the present disclosure do not represent any order, quantity, or importance, but are only used for distinguishing different components. “Include”, “contain”, or a similar term means that an element or article appearing before the term covers an element or article and equivalent thereof listed after the term, and other elements or articles are not excluded.

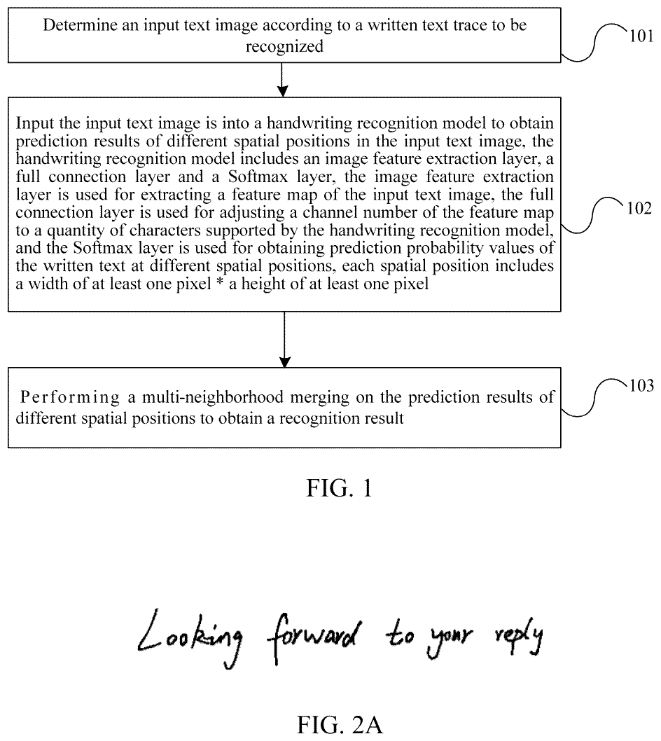

As shown in FIG. 1, an embodiment of the present disclosure provides a handwriting recognition method, which includes the following steps:
Step 101, an input text image is determined according to a written text trace to be recognized;
Step 102, the input text image is input into a handwriting recognition model to obtain prediction results of different spatial positions in the input text image, the handwriting recognition model includes an image feature extraction layer, a full connection layer and a Softmax layer, the image feature extraction layer is used for extracting a feature map of the input text image, the full connection layer is used for adjusting a channel number of the feature map to a quantity of characters supported by the handwriting recognition model, and the Softmax layer is used for obtaining prediction probability values of the written text at different spatial positions, and each spatial position includes a width of at least one pixel*a height of at least one pixel;
Step 103, multi-neighborhood merging is performed on the prediction results of different spatial positions to obtain a recognition result.

In the embodiment of the present disclosure, one spatial position in the input text image may correspond to m*n pixels in the input text image, where m is the number of pixels contained along a height direction and n is the number of pixels contained along a width direction. Exemplarily, it is assumed that, the input text image (with a size of 1×H×W) is passed through the image feature extraction layer to output a feature map f with a size of

$$512 \times \frac{H}{I 6} \times \frac{W}{8} .$$

The feature map f is passed through the full connection layer to adjust the number of channels to K, and K is the number of characters supported by the handwriting recognition model that is, a feature map f′ of

$$K \times \frac{H}{I 6} \times \frac{W}{8}$$

is obtained. The feature map f′ is passed through the Softmax layer to obtain prediction probability values of the written text at different spatial positions, then one spatial position in the input text image corresponds to a size of 16*8 pixels in the input text image. However, magnitudes of m and n are not limited in the embodiments of the present disclosure, and m and n may be set according to the size of the feature map output by the actual image feature extraction layer.

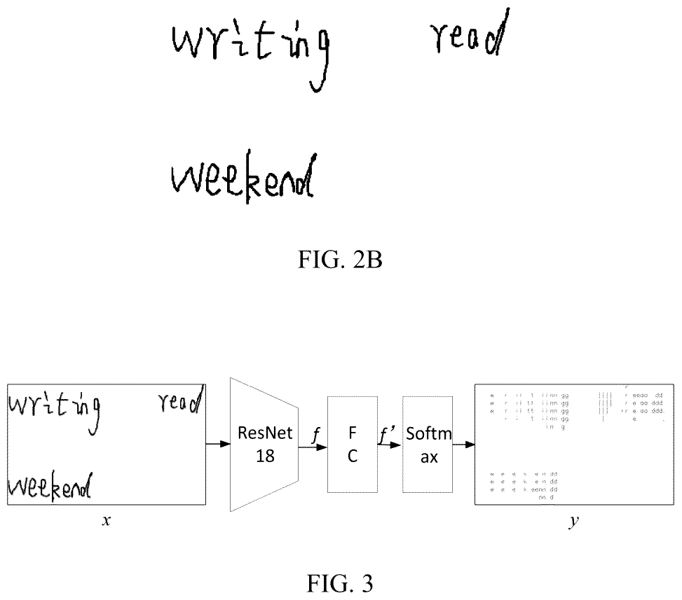

As shown in FIGS. 2A and 2B, with the handwriting recognition method according to the embodiment of the present disclosure, a single line of the written text or a plurality of lines of the written text can be recognized. In the handwriting recognition method according to an embodiment of the present disclosure, an input text image is determined according to a written text trace to be recognized, and then the input text image is input into a handwriting recognition model. The handwriting recognition model includes an image feature extraction layer, a full connection layer and a Softmax layer, so as to obtain prediction results of different spatial positions, and multi-neighborhood merging is performed on the prediction results of different spatial positions to obtain a recognition result, with a simple network structure and a high recognition accuracy. The written text described in the embodiment of the present disclosure can be English words or any other characters, such as Chinese characters, numbers, pinyin, etc, and the embodiments of the present disclosure are not limited thereto.

In some exemplary embodiments, the written text to be recognized includes at least one character, the at least one character can include words, letters, numbers, arithmetic symbols, punctuation marks and any other special characters.

In an embodiment of the present disclosure, special characters are symbols that are less commonly used and difficult to be directly input than conventional or commonly used symbols, and have a wide variety of types. Exemplarily, the special characters may include: mathematical symbols (for example, ≈, ≡, ≠, =, ≤, ≥, <, >, etc), unit symbols (for example, ° C., Å, %, ‰, m²,etc), pinyin characters (for example, ã, á, ǎ, à, ō, ó, ǒ, ò, etc.), etc.

Exemplarily, it is assumed that the written text to be recognized may include any one or more of the 56 characters as shown in Table 1.

TABLE 1

| id | Character |
|---|---|
| 0 | Space |
| 1 | a |
| 2 | b |
| 3 | c |
| 4 | d |
| 5 | e |
| 6 | f |
| 7 | g |
| 8 | h |
| 9 | i |
| 10 | j |
| 11 | k |
| 12 | l |
| 13 | m |
| 14 | n |
| 15 | o |
| 16 | p |
| 17 | q |
| 18 | r |
| 19 | s |
| 20 | t |
| 21 | u |
| 22 | v |
| 23 | w |
| 24 | x |
| 25 | y |
| 26 | z |
| 27 | A |
| 28 | B |
| 29 | C |
| 30 | D |
| 31 | E |
| 32 | F |
| 33 | G |
| 34 | H |
| 35 | I |
| 36 | J |
| 37 | K |
| 38 | L |
| 39 | M |
| 40 | N |
| 41 | O |
| 42 | P |
| 43 | Q |
| 44 | R |
| 45 | S |
| 46 | T |
| 47 | U |
| 48 | V |
| 49 | W |
| 50 | X |
| 51 | Y |
| 52 | Z |
| 53 | , |
| 54 | . |
| 55 | ? |

In some exemplary embodiments, each character includes at least one stroke, and one stroke is a written trace between pen-down and pen-up for one time. As an example, the character “L” includes one stroke and the character “f” includes two strokes.

In some exemplary embodiments, each stroke includes at least one trace point.

In some exemplary embodiments, information of the trace point may be divided into multiple arrays, each array includes attribute information of multiple trace points in one stroke, and the attribute information includes X-axis coordinates, Y-axis coordinates, pen-up flag bits, and the like.

In this embodiment, the attribute information of the multiple trace points in one stroke forms one array. For example, the Chinese character “ [symbol] ” includes one stroke “horizontal”, which can include about 100 trace points, and the attribute information of each trace point includes X-axis coordinates, Y-axis coordinates, pen-up flag bits and the like. In some other exemplary embodiments, the attribute information may also include time stamp, pressure information, speed information and the like.

In some exemplary embodiments, determining the input text image according to the written text trace to be recognized in Step 101 may include the following steps:
Step 1011, the written text trace to be recognized is acquired to determine an equivalent number of lines of the written text;
Step 1012, a height of the input text image is calculated according to the equivalent number of lines of the written text, and the input text image is determined according to the height of the input text image.

In some other exemplary embodiments, determining the input text image according to the written text trace to be recognized in Step 101 may also include processes such as scaling, denoising and the like on the input text image, and the embodiments of the present disclosure are not limited thereto.

In some exemplary embodiments, determining the equivalent number of lines of the written text may include:
the written text trace to be recognized is correspondingly disposed in a two-dimensional coordinate system, wherein the two-dimensional coordinate system includes X-axis coordinates and Y-axis coordinates;
a height trace_sl_h of a single-line text in the written text trace to be recognized is calculated;
a height trace_h of entire written text is calculated, where trace_h=(Ymax−Ymin+1), Ymin is a minimum value of Y-axis coordinates of all strokes, and Ymin is a maximum value of Y-axis coordinates of all strokes;
an equivalent number of lines of written text raw_num is determined, where raw_num=trace_h/trace_sl_h.

In the embodiment of the present disclosure, the height trace_sl_h of the single-line text in the written text trace to be recognized can be calculated using an average single-line height of the entire written text or using the highest single-line height of the entire written texts. In an embodiment of the present disclosure, when the characters contained in the written text are mainly English characters, the height of the single-line text in the written text can be approximately calculated by a length of a longest stroke in the single-line text. In an embodiment of the present disclosure, the length of each stroke may be calculated using the Euclidean distance formula, may be approximately calculated using the height of each stroke, may be approximately calculated using the larger of the height of each stroke and the width of each stroke, and the like, and the embodiments of the present disclosure are not limited thereto.

In some exemplary embodiments, the length stroke_len of each stroke in the written text trace to be recognized is approximately calculated according to the following formula: stroke_len=max (xmax−xmin+1, ymax−ymin+1), xmin is a minimum value of X-axis coordinates of the current stroke, xmax is a maximum value of X-axis coordinates of the current stroke, ymin is a minimum value of Y-axis coordinates of the current stroke, ymax is a maximum value of Y-axis coordinates of the current stroke, and max (A, B) represents taking the larger of A and B.

In some exemplary embodiments, the height trace_sl_h of the single-line text in the written text trace to be recognized is determined as the length max (stroke_len) of the longest stroke of all the strokes, where max (stroke_len) means taking the maximum of all stroke lengths stroke_len.

As an example, the equivalent number of lines of the written text shown in FIG. 2A is 1.18 lines, and the equivalent number of lines of the written text shown in FIG. 2B is 3.2 lines (spacing between the two lines is about a single line spacing) calculated according to the above method. In the embodiment of the present disclosure, the equivalent number of lines refers to a sum of the number of lines of the actual written text and an equivalent number of lines of a blank area around each line of the written text. As shown in FIG. 2B, when the height of the blank area occupied between two lines of the text is larger, the equivalent number of lines of written text shown in FIG. 2B is larger.

In some other exemplary embodiments, the length of each stroke in the written text trace to be recognized may also be calculated according to other methods, the embodiments of the present disclosure are not limited thereto. As an example, the length stroke_len of each stroke in the written text trace to be recognized may be calculated according to the following formula: stroke_len=\sqrt{(xmax−xmin+1)²+(ymax−ymin+1)²}, xmin is a minimum value of X-axis coordinates of the current stroke, xmax is a maximum value of X-axis coordinates of the current stroke, ymin is a minimum value of Y-axis coordinates of the current stroke, ymax is a maximum value of Y-axis coordinates of the current stroke.

In some exemplary embodiments, calculating the height of the input text image according to the equivalent number of lines of the written text includes:
the height of the input text image input_h=[raw_numxa], where raw_num is the equivalent number of lines of the written text, a is a height of a sample text image used in training the handwriting recognition model or the height of the written text in the sample text image used, [ ] is a rounding symbol (which can be rounding up, rounding down or rounding), a is a natural number greater than or equal to 1, and the number of lines of the written text in the sample text image is 1.

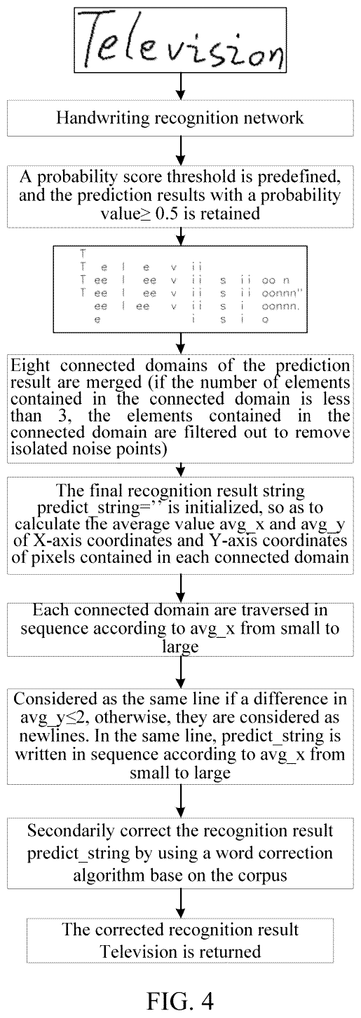

The handwriting recognition method according to the embodiment of the disclosure has simple network structure, only needs a single line of data annotation during model training, and uses a single line of the sample text image for model training. During reasoning recognition, the single-line or multi-line written text can be processed by reasoning recognition. When using a single-line sample text image for model training, the height of the input single-line written text can be unified to “a” pixels (when using the single-line for model training, the blank area around the written text in the input single-line sample text image is cut out as much as possible, such as the input Television picture shown in FIG. 4, so the height of the written text in the sample text image can be approximately equal to the height of the sample text image). For the multi-line written text trace, the height of the input text image is determined by the method according to the embodiment of the present disclosure, so that the height of each line of the written text in the input text image is approximately controlled at “a” pixels.

Exemplarily, “a” may be 80. When a single-line sample text image is used for model training, and the height of the input text image is unified to 80 pixels. For the written text trace of multi-line, the height of the input text image needs to be determined so that the height of each line of written text is approximately controlled at 80 pixels. Therefore, in the embodiment of the present disclosure, a method is designed for adaptively determining the height of the input text image, and its implementation steps are as follows:
Step 1: a length stroke_len of each stroke is calculated, and a height trace_sl_h of a single-line text in the written text trace to be recognized is approximately calculated as a length max (stroke_len) of the longest stroke among all strokes. As an example, the length stroke_len of each stroke is approximately calculated using the following method: stroke_len=max (xmax−xmin+1, ymax−ymin+1), xmin is the minimum value of X-axis coordinates of the current stroke, xmax is the maximum value of X-axis coordinates of the current stroke, ymin is the minimum value of Y-axis coordinates of the current stroke, ymax is the maximum value of Y-axis coordinates of the current stroke.
Step 2: a height trace_h of the written text is calculated, where trace_h=(Ymax−Ymin+1), Ymin is a minimum value of Y-axis coordinates of all the strokes, and Ymax is a maximum value of Y-axis coordinates of all strokes.
Step 3: an equivalent number of lines raw_num of the current written text to be recognized is determined, where raw_num=trace_h/trace_sl_h; based on this, the height input_h of the input text image is calculated, where input_h=[raw_num×80].

According to the method for adaptively determining the height of the input text image, a height of the input text image corresponding to the single-line written text shown in FIG. 2A is calculated to be [1.18×80]=[94.4]=94 pixels. A height of the input text image corresponding to the single-line written text shown in FIG. 2B is [3.2×80]=256 pixels.

In some exemplary embodiments, determining the input text image based on the height of the input text image includes:
a scaled factor ratio between the input text image and the written text trace to be recognized is calculated, wherein ratio=input_h/trace_h, where input_h is the height of the input text image and trace_h is the height of the written text trace;
coordinates of trace points in the input text image are determined, wherein point_X=(point_X−xmin)×ratio, point_Y=(point_Y−ymin)×ratio, point_X and point_Y represent X-axis coordinates and Y-axis coordinates of the trace points in the written text trace to be recognized, respectively, xmin and ymin represent a minimum value of X-axis coordinates and a minimum value of the Y-axis coordinates of all trace points in the written text trace to be recognized, respectively, and point_X and point_Y represent X-axis coordinates and Y-axis coordinates of the trace points in the input text image, respectively.

In the embodiment of the present disclosure, since the blank portion around the written text in the input text image (excluding the blank area between multiple lines of the written text) is basically cut out, the height input_h of the input text image is approximately equal to a difference between the maximum value of Y-axis coordinates of all trace points and the minimum value of Y-axis coordinates of all trace points in the input text image, and a width of the input text image is approximately equal to a difference between the maximum value of X-axis coordinates of all trace points and the minimum value of X-axis coordinates of all trace points in the input text image.

In some exemplary embodiments, the method further includes: in units of strokes, all trace points of each stroke in the input text image are sequentially connected with a line having a line width b to obtain the input text image, where b is greater than or equal to a width of one pixel.

In the embodiment of the present disclosure, after the height of the input text image is calculated by the aforementioned method, the trace points are converted into the input text image with corresponding height by means of trace point mapping (ensuring that the line width of all characters in the input text image is consistent).

Exemplarily, b may be in a wide of 2 pixels. After the height of the input text image is calculated by the method for calculating the height of the input image, the trace point is converted into the input text image with corresponding height by means of trace point mapping (ensuring the line width of all characters in the image is consistent). The implementation process of trace point mapping includes:
Step 1: the scaled factor is calculated, ratio=input_h/trace_h;
Step 2: trace points are mapped, point_X=(point_X−xmin)×ratio, point_Y=(point_Y−ymin)×ratio, wherein, point_X and point_Y respectively represent X-axis coordinates and Y-axis coordinates of original trace points before mapping, xmin and ymin represent minimum values of X-axis coordinates and Y-axis coordinates of all original trace points, point_Y and point_Y respectively represent X-axis coordinates and Y-axis coordinates of trace points after mapping;
Step 3: taking stroke as a unit, all trace points (mapped trace points) in each stroke are sequentially connected with a line in a line width of 2 to obtain the input text image.

Taking the handwriting recognition model shown in FIG. 3 as an example, the scaled ratio is calculated based on the originally collected trace points (a series of xy coordinates), and the mapped trace points are obtained according to the scaled ratio. An all-white image with a height H=Ymax−Ymin+1, a width W=Xmax−Xmin+1, and pixel values of 255 (where Xmin, Ymin, Xmax, Ymax are the minimum values of X-axis coordinates, the minimum values of Y-axis coordinates, the maximum values of X-axis coordinates and the maximum values of Y-axis coordinates of the mapped trace points, respectively) is initially constructed. On the all-white image, all trace points in unit of stroke are sequentially connected by lines in a line width of b to obtain the input text image.

The input text image obtained by mapping the trace points is input into the handwriting recognition model shown in FIG. 3 for multi-line text recognition, and the recognition effect is shown in FIG. 3. The input text image x (in a size of 1×H×W, where 1 is the number of channels, H is the height, W is the width) is passed through an image feature extraction layer (in the embodiment of the present disclosure, the image feature extraction layer may be a Convolutional Neural Network (CNN), for example, the image feature extraction layer may be a feature extraction network ResNet 18, however, the embodiment of the present disclosure does not limit this) to output a feature map f in size of

$$512 \times \frac{H}{I 6} \times \frac{W}{8} ,$$

the feature map f is passed through a Full Connection (FC) layer to adjust the number of channels to K (K is the number of character classes supported and recognized by the model, and each channel represents predicted probability values of different characters respectively, and for example, K can be 56), so as to obtain a feature map f′ in size of

$$K \times \frac{H}{I 6} \times \frac{W}{8} ,$$

and finally the feature map f′ is passed through the Softmax layer to obtain the prediction probability values of characters in different spatial positions, the character id with the largest prediction probability value is taken as the character id at that position (or a probability score threshold can be predefined, and the prediction result with the prediction probability value greater than or equal to the probability score threshold can be reserved, and the probability score threshold can be provided as 0.5, for example), and the prediction result y of each spatial position is output with reference to the character and id reference table shown in Table 1.

In the embodiment of the present disclosure, multi-neighborhood merging can also be referred to as multi-connected domain merging. In some exemplary embodiments, multi-neighborhood merging is performed on prediction results of different spatial positions, specifically, eight-neighborhood merging is performed on prediction results of different spatial positions. That is, for each pixel with a value of 1, if there is one pixel with a value of 1 in its eight neighborhood, then these two pixels are classified into one character. Eight neighborhoods or eight connected domains refer to the upper, lower, left, right, upper left, upper right, lower left and lower right of corresponding positions, which are closely adjacent positions and obliquely adjacent positions, with a total of eight directions. For example, in the prediction result y of each spatial position in FIG. 3, three w are merged into one w, and four r are merged into one r . . . .

In some exemplary embodiments, if the number of elements contained in the connected domain is less than 3, the elements contained in the connected domain are filtered out to remove isolated noise points when multi-neighborhood merging is performed on prediction results of different spatial positions.

In some exemplary embodiments, the method further includes a same-line alignment for the prediction results of different spatial positions.

In some exemplary embodiments, the same-line alignment for the prediction results of different spatial positions includes:
an average value avg_x of X axis coordinates of all pixels and an average value avg_y of Y axis coordinates of all pixels in each connected domain after multi-neighborhood merging are calculated;
each connected domain is traversed in sequence according to avg_x from small to large, and the pixels with a difference in avg_y less than or equal to c are same-line aligned, and c is less than or equal to 5 pixel width.

In this embodiment, after multi-neighborhood merging, the positions of each character in the same line may not be at the same height, and there may be a deviation of one or two pixels or several pixels from top to bottom. The characters in the same line are aligned by calculating avg_x and avg_y. Exemplarily, c may be in wide of 2 pixels. Pixels with a difference in avg_y less than or equal to 2 are considered as the same line, and same-line alignment is performed; otherwise, they are considered as newlines.

For example, as shown in FIG. 4, a written text trace to be recognized including a handwriting Television is input into a handwriting recognition network, a probability score threshold is predefined (assumed to be 0.5), prediction results with a prediction probability value greater than or equal to the probability score threshold is retained, and prediction results y of different spatial positions is obtained, eight connected domains of the prediction result y are merged, and when multi-neighborhood merging is performed on the prediction result of each spatial position, if the number of elements contained in the connected domain is less than 3, the elements contained in the connected domain are filtered out to remove isolated noise points. The final recognition result string predict_string is initialized, so as to calculate the average value avg_x and avg_y of X-axis coordinates and Y-axis coordinates of pixels contained in each connected domain, each connected domain are traversed in sequence according to avg_x from small to large, and pixels with a difference in avg_y less than or equal to c are same-line aligned. In the same line, the final recognition result string predict_string is written in sequence according to avg_x from small to large, and the corrected recognition result Television is returned.

In some exemplary embodiments, the method further includes:

English words in the recognition result are automatically corrected according to a pre-established corpus.

The handwriting recognition method according to an embodiment of the present disclosure improves the recognition accuracy by adding a word automatic correction algorithm based on dynamic programming in the network post-processing stage.

In embodiments of the present disclosure, word correction relies on the establishment of a corpus, for example, a corpus consists of the following three parts:
(1) Gutenberg Corpus data (Gutenberg Corpus contains approximately 36,000 free e-books);
(2) Wikipedia;
(3) a list of the most commonly used words in the British National Corpus.

However, embodiments of the present disclosure are not limited thereto.

In some exemplary embodiments, automatically correcting English words in recognition result are based on a pre-established corpus includes:
it is detected whether the English words in the recognition result are the English words in the corpus or not;
when the recognition result contains one or more English words that are not the English words in the corpus, the one or more English words are marked as words to be corrected, and a minimum edit distance from each word to be corrected to the English words in the corpus is calculated (in the calculation, English words in the corpus whose similarity ratio with the words to be corrected is greater than or equal to a predefined threshold value can be selected for calculation, for example, the predefined threshold value can be 50%);

Each word to be corrected is corrected according to the calculated minimum edit distance.

In the embodiment of the present disclosure, the minimum edit distance refers to minimum editing times required to change a word from the current word to another word, and the editing operations are specifically divided into three types: insertion, deletion and replacement.

In some exemplary embodiments, correcting each word to be corrected based on the calculated minimum edit distance includes:
a current minimum edit distance detection value is initialized to 1;
it is detected whether a first English word exists and the number of the first English words, wherein the minimum edit distance between the first English word and the current word to be corrected is the current minimum edit distance detection value;
when the first English word exists and the number of the first English word is 1, the word to be corrected is corrected as the first English word;
when the first English words exist and the number of the number of the first English words is two or more, the two or more first English words are sorted according to the occurrence times in the corpus to obtain a first English word with the most occurrence times in the corpus, and the word to be corrected is corrected as the first English word with the most occurrence times in the corpus;
when the first English word does not exist, the current minimum edit distance detection value is self-increased by 1, and the step of detecting whether the first English word exists and the number of the first English word is returned to carry out cyclic detection until the current minimum edit distance detection value is greater than a predefined minimum edit distance threshold value and the detection is stopped.

In some exemplary embodiments, the predefined minimum edit distance threshold is 2.

In some exemplary embodiments, correcting each word to be corrected based on the calculated minimum edit distance includes:
it is detected whether an English word with a minimum edit distance of 1 exists and the number of English words with a minimum edit distance of 1;
when a English word with a minimum edit distance of 1 exists and the number of English words with a minimum edit distance of 1 is 1, the word to be corrected is corrected to the English word with a minimum edit distance of 1;
When two or more English words with a minimum edit distance of 1 exist and the number of English words with a minimum edit distance of 1 is 2 or more, the two or more English words with a minimum edit distance of 1 are sorted according to the occurrence times in the corpus to obtain the English words with the most occurrence times and the minimum edit distance of 1 in the corpus, and the words to be corrected are corrected as the English words with the most occurrence times and the minimum edit distance of 1 in the corpus;
when a English word with a minimum edit distance of 1 does not exist, it is detected whether an English word with a minimum edit distance of 2 exists and the number of English words with a minimum edit distance of 2;
when a English word with a minimum edit distance of 2 exists and the number of English words with a minimum edit distance of 2 is 1, the word to be corrected is corrected to the English word with a minimum edit distance of 2;
When two or more English words with a minimum edit distance of 2 exist and the number of English words with a minimum edit distance of 2 is 2 or more, the two or more English words with a minimum edit distance of 2 are sorted according to the occurrence times in the corpus to obtain the English words with the most occurrence times and the minimum edit distance of 12 in the corpus, and the words to be corrected are corrected as the English words with the most occurrence times and the minimum edit distance of 2 in the corpus;

In some exemplary embodiments, calculating a minimum edit distance from each word to be corrected to an English word in the corpus includes:
a state transition matrix is constructed according to the following formula, and recursively calculated from D[1,1] to D[M, N]:

$$D [ i , j ] = min \{ \begin{matrix}D [ i - 1 , j ] + del\_cost \\ D [ i , j - 1 ] + ins\_cost \\ D [ i - 1 , j - 1 ] + \{ \begin{matrix}rep\_cost , src [ i ] \neq tar [ j ] \\ 0 , src [ i ] = tar [ j ]\end{matrix}\end{matrix} ;$$

wherein, D[i, j] represents a minimum edit distance from an i-th element of the word to be corrected to a j-th element of a target English word; a letter number of the word to be corrected is M, a letter number of the target English word is N, i is a natural number between 0 and M, j is a natural number between 0 and N, M and N are both natural numbers greater than or equal to 1, del_cost is a deletion cost, and when a character needs to be deleted, del_cost=1; ins_cost is a insertion cost, and when a character needs to be inserted, ins_cost=1; rep_cost is the replacement cost, and rep_cost=1 when a character needs to be replaced;
D[M, N] is regarded as the minimum edit distance from the word to be corrected to the target English word.

In the embodiment of the present disclosure, recursively calculating from D[1,1] to D[M, N] means that the matrix element D[1,1] is calculated first, and then the following matrix elements adjacent to the matrix element D[1,1] are calculated: D[1,2], D[2,2], D[2,1], and the following matrix elements adjacent to the matrix element D[1,2], D[2,2], D[2,1] are calculated: D[1,3], D[2,3], D[3,1], D[3,2], D[3,3] . . . until D[M, N].

In some exemplary embodiments, an implementation process of automatically correcting English words in recognition result is based on a pre-established corpus is as the following:
(I) all the words in the corpus are taken out to count the occurrence times;
(II) For the word to be corrected, the minimum edit distance from the word to be corrected to the target English word is calculated by using the dynamic programming algorithm, and the words whose minimum edit distance to the current word to be corrected is 0, 1 and 2 are found out in sequence. The minimum edit distance refers to minimum editing times required to change a word from the current word to another word, and the editing operations are specifically divided into three types: insertion, deletion and replacement. For example, the minimum edit distance from pay to play is 1 (one insert operation); the minimum edit distance from pllay to play is 1 (one delete operation); the minimum edit distance from alay to play is 1 (one replacement operation).

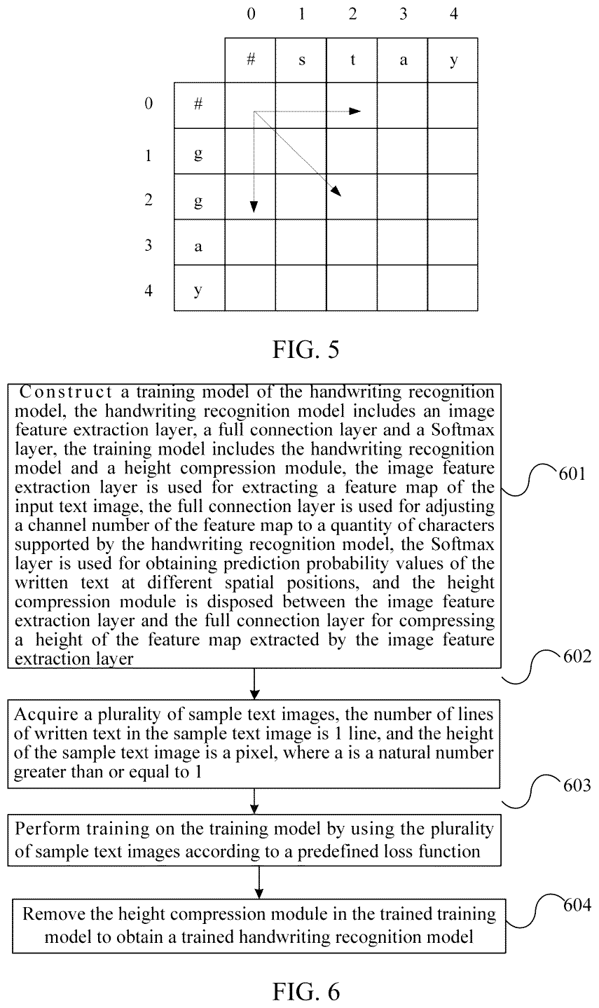

Taking ggay->stay as an example, the implementation steps for calculating the minimum edit distance from ggay to stay are as follows:
1) a matrix in which the source word ggay is a column and the target word stay is a row is constructed, and add null characters #in front of ggay and stay respectively to obtain an initial matrix of dynamic programming algorithm as shown in FIG. 5;
2) D[i, j] is used to represent the minimum edit distance required from the source word [0: i] to the target word [0: j], since the number of letters of both the source word and the target word is 4, D[4, 4] is taken as the minimum edit distance from ggay to stay, and D[i, j] is calculated according to the state transition matrix shown in formula (1).

$$D [ i , j ] = min \{ \begin{matrix}D [ i - 1 , j ] + del\_cost \\ D [ i , j - 1 ] + ins\_cost \\ D [ i - 1 , j - 1 ] + \{ \begin{matrix}rep\_cost , src [ i ] \neq tar [ j ] \\ 0 , src [ i ] = tar [ j ]\end{matrix}\end{matrix} \qquad ( 1 )$$

Taking D[1, 1] as an example, the minimum edit distance of g->s is illustrated, and g->s can be realized in three ways:
insert+delete: g->gs->s, edit distance 1+1=2;
delete+insert: g->#->s, edit distance 1+1=2;
replace: g->s, edit distance 1;
therefore, the minimum edit distance D[1, 1] of g->s=1.

Then D[1, 2], D[2, 1], D[2, 2], D[1, 3], D[3, 1], D[3, 2], D[3, 3], D[1, 4], D[3, 4], D [4, 1], D[4, 2], D[4, 2], D[4, 4], D[4, 4] are sequentially calculated, and finally the minimum edit distance from ggay to stay is 2.

In some exemplary embodiments, the final correction result of the word is determined in three priority order:
words with edit distance of 0 (word itself)>words with edit distance of 1>words with edit distance of 2;
whether the word appears in the corpus;
number of occurrence times in the corpus.

As shown in FIG. 6, an embodiment of the disclosure also provides a training method of a handwriting recognition model, which includes the following steps:
Step 601, a training model of the handwriting recognition model is constructed, wherein the handwriting recognition model includes an image feature extraction layer, a full connection layer and a Softmax layer, the training model includes the handwriting recognition model and a height compression module, wherein the image feature extraction layer is used for extracting a feature map of the input text image, the full connection layer is used for adjusting a channel number of the feature map to a quantity of characters supported by the handwriting recognition model, the Softmax layer is used for obtaining prediction probability values of the written text at different spatial positions, and the height compression module is disposed between the image feature extraction layer and the full connection layer for compressing the height of the feature map extracted by the image feature extraction layer;
Step 602, a plurality of sample text images are obtained, wherein the number of lines of written text in the sample text image is 1 line, and the height of the sample text image is a pixel, and a is a natural number greater than or equal to 1;
Step 603, the training model is trained by adopting a plurality of the sample text images according to a predefined loss function;
Step 604, the height compression module in the trained training model is removed to obtain a trained handwriting recognition model.

In the embodiment of the present disclosure, the handwriting recognition method for the global classification of the feature map requires that the model can perform pixel-level prediction, and the sample text image containing a single-line written text is used for training in the training process, so that the model has pixel-level prediction ability through learning.

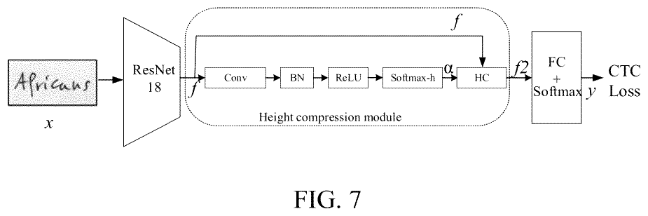

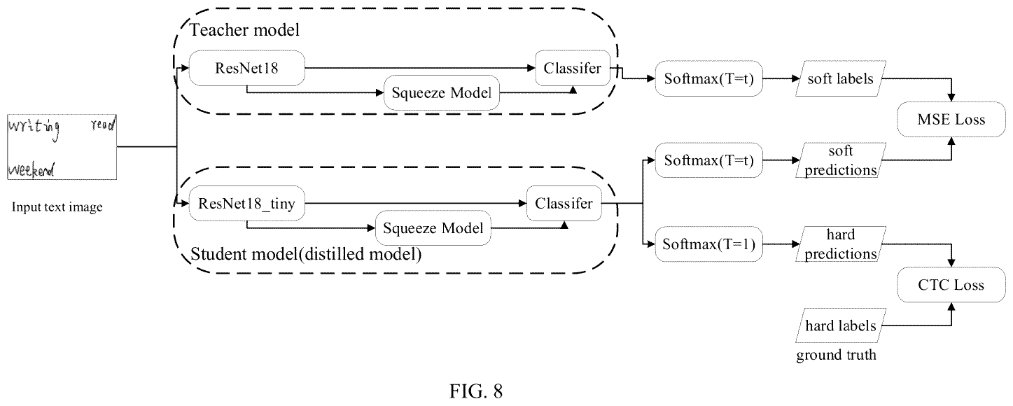

In some exemplary embodiments, as shown in FIG. 7, the height compression module includes a second convolution (Conv) layer, a batch normalization (BN) layer, an activation function layer, a weight calculation (Softmax-h) layer, and a height compression (HC) layer, wherein:
the second convolution layer is used for extracting the features of the feature map extracted by the image feature extraction layer;
the batch normalization layer is used for normalizing the features extracted by the second convolution layer;
the activation function layer is used to increase the nonlinearity of the height compression module;
the weight calculation layer is used for calculating a weight value of each pixel in all pixels with the same width value;
the height compression layer is used for multiplying each column of the feature map of the input text image in a height direction and the corresponding position of the corresponding column of the weight value in the height direction and sum them up to obtain a feature map after height compression. In the embodiment of the present disclosure, a transverse direction of the image is the width direction, and a longitudinal direction of the image is the height direction.

In some exemplary embodiments, the activation function layer may use ReLU as the activation function, however, the embodiments of the present disclosure are not limited thereto.

As an example, as shown in FIG. 7, a text image x (in size of 1×H×W, where 1 is the number of channels, H is the height, and W is the width) is input, and the image feature extraction layer (which can be ResNet 18, for example) extracts features to obtain a feature map f in size of

$$512 \times \frac{H}{16} \times \frac{W}{8} .$$

In order to allow training of Connectionist Temporal Classification (CTC) (CTCloss is a loss function designed for sequence learning, so using CTC loss needs to transform the two-dimensional feature map output from the last layer of the model into one-dimensional sequence), a height compression module Squeeze Model is introduced to compress the two-dimensional feature map f into one-dimensional (the implementation process of the compression is as follows: the two-dimensional feature map f is passed through the second convolution layer, the batch normalization layer, the activation function layer and the weight calculation layer, so as to obtain a weight feature map α in size of

$$1 \times \frac{H}{16} \times \frac{W}{8}$$

(α includes the weight value of each pixel in all pixels with the same width value)), f is passed through the height compression layer such that each column of f is respectively multiplied by the corresponding positions of the same column of α, and then summed to obtain a one-dimensional feature map f2 in size of

$$512 \times 1 \times \frac{W}{8} .$$

In FIG. 7, Softmax-h represents deriving Softmax in unit of column for the feature map f, as in formula (4), and finally the feature size W/8×K is output after being passed through full connection (FC) layer and the Softmax layer.

$$f = F ( x ) , f ∈ {R}^{512 \times h \times w} \qquad ( 2 )$$

$$e = S ( f ) , e ∈ {R}^{1 \times h \times w} \qquad ( 3 )$$

$${α}_{i , j} = \frac{exp ( {e}_{l , j} )}{{\sum }_{{i}^{′} = 1}^{h} exp ( {e}_{{i}^{′} , j} )} , ( i ∈ [ 1 , h ] , j ∈ [ 1 , w ] ) \qquad ( 4 )$$

$$f {2}_{j} = {\sum }_{i = 1}^{h} {α}_{i , j} {f}_{i , j} \qquad ( 5 )$$

$$c = softmax ( FC ( f 2 ) ) , c ∈ {R}^{w \times K} \qquad ( 6 )$$

wherein, F in formula (2) represents the feature extractor ResNet 18, S in formula (3) represents the second convolution layer, the batch normalization layer and the activation function layer in height compression module Squeeze Model, formula (4) represents the weight calculation layer in height compression module Squeeze Model, formula (5) represents the height compression layer in height compression module Squeeze Model (which multiplies each column of f and corresponding positions of the same column of α and sums them), and formula (6) represents FC layer and Softmax layer.

$$h = \frac{H}{16} , w = \frac{W}{8} ,$$

K is the number of character classes that supported and recognized by the model.

In some exemplary embodiments, the predefined loss function includes a connectionist temporal classification CTC loss function.

In some other exemplary embodiments, a predefined loss functionLₜₒₜₐₗ includes a CTC loss functionL_{CTC} and a auxiliary loss functionLₛᵤₚ, wherein,

$${L}_{sup} = \frac{1}{K} {\sum }_{k = 1}^{K} \vert {h}_{k} {y}_{k} \vert ,$$

K is the number of character classes that the training model can recognize, yₖ is a probability score of the k-th character predicted by the training model.

$${h}_{k} = \{ \begin{matrix}0 , & k ∈ in\_label \\ 1 , & k ∈ out\_label\end{matrix} \qquad ( 7 )$$

$${L}_{total} = {L}_{C T C} + \frac{1}{K} {\sum }_{k = 1}^{K} \vert {h}_{k} {y}_{k} \vert \qquad ( 8 )$$

Wherein, k∈in_label represents the predicted character is the same as the hard labels, k∈out_label represents the predicted character is different from the hard labels.

In the training method according to an embodiment of the present disclosure, an auxiliary loss function

$$\frac{1}{K} {\sum }_{k = 1}^{K} \vert {h}_{k} {y}_{k} \vert$$

is added on the basis of CTC loss in order to suppress the occurrence of characters outside the label (recorded as negative pixels) in the prediction process. According to the fact whether the predicted characters are included in the hard labels, the predicted characters are divided into in_label and out_label, and the occurrence of negative pixels in the prediction process is suppressed by adding the auxiliary loss function.

The training method according to an embodiment of the present disclosure can also carry out lightweight processing on the handwriting recognition model through channel pruning and knowledge distillation, so that the parameter amount and calculation amount of the model can be significantly reduced on the premise that the recognition accuracy is not obviously reduced.

In some exemplary embodiments, the image feature extraction layer includes a plurality of first convolution layers, and the training method further includes:
a channel pruning ratio of each first convolution layer is determined in the trained training model;
channels to be deleted for each first convolution layer are obtained;
a dependency graph is constructed, wherein the dependency graph includes a dependence relationship among the plurality of first convolution layers;
a pruning operation is performed on the channel to be pruned, and the channel is aligned according to the dependency relationship.

According to the training method of the embodiment of the present disclosure, the handwriting recognition model can be light-weighted by channel pruning (channel pruning is performed only on the first convolution layer, rather than on the full connection layer). Exemplary, the channel pruning may include the following steps:
S1, the handwriting recognition model is trained by using the training model to obtain a trained training model;
S2, a channel pruning ratio of each first convolution layer is determined in the trained training model;
a total compression ratio of the model is determined according to the hardware resources of the model deployment environment, in the embodiment of the present disclosure, the total compression ratio=the number of deleted channels/the number of channels of the model before compression, when the total compression ratio is 0.75, the pruned model retains ¼ channels of the original model.

A grade of the clipping rate is determined according to the ratio of the total number of channels of the image feature extraction layer to the maximum number of output channels of the first convolution layer. Considering that different network layers have different importance to recognition tasks, different network layers will be graded and given different clipping rates, and different network layers can have different clipping rates. For example, when the image feature extraction layer of the embodiment of the present disclosure is ResNet18, the total number of channels of ResNet18 is 3904, and the maximum number of output channels of the first convolution layer is 512. In order to divide all channels in the same first convolution layer into the same grade, 3904÷512 is rounded to 7, so a grade-7 clipping rate can be selected.

Assuming that the total compression ratio Ratio of the model is 0.75 and the grade-7 clipping rate is adopted, the channel compression ratios obtained according to formula (9) is [Ratio−value*3, Ratio−value*2, Ratio−value*1, Ratio+value*1, Ratio+value*2, Ratio+value*3]=[0.5625, 0.625, 0.6875, 0.75, 0.8125, 0.875, 0.9375].

$$value = \{ \begin{matrix}( 1 - Ratio ) \div 4 , & Ratio \geq 0.43 \\ Ratio \div 4 , & Ratio < 0.43\end{matrix} \qquad ( 9 )$$

The output channel of each first convolution layer in the handwriting recognition model (output_channel: the number of convolution kernels in the corresponding convolution layer) is counted and divided into seven parts according to the sequence in the network structure. According to the channel compression ratio mentioned above, the first convolution layer in each part is respectively assigned with a corresponding channel pruning ratio (for example, a channel pruning ratio of the first convolution layer in the first part is 0.5625, a channel pruning ratio of the first convolution layer in the second part is 0.625, and so on), and the number of channels to be deleted in each first convolution layer is obtained. The ratio of the total number of the clipped channel to the number of channels before clipping is 0.75.
S3, id of the channels to be deleted for each first convolution layer is obtained;
the sum of absolute values of weight of each convolution kernel in each first convolution layer of the original handwriting recognition model trained in S1 is calculated, and they are sorted according to the sequence from small to large, in combination with the channel deletion ratio of each first convolution layer obtained in S2, the id of the channels to be deleted in each first convolution layer is determined (the convolution kernels with small sum of absolute values of weight are deleted to reduce the number of channels of the feature map output by the first convolution layer).
S4: a dependency graph is constructed and a pruning operation is executed;
in order to ensure the connection between the front and back network layers after pruning, the dependency relationship between each layer of the whole network should be constructed before pruning (the number of channels of each convolution kernel in the latter convolution layer should be equal to the number of convolution kernels in the previous convolution layer). Based on the id of the channels to be deleted of each first convolution layer obtained in S3, a channel deletion is performed on the corresponding network layer. In the pruning process, the whole dependency graph is traversed, channels are automatically aligned according to the dependency relationship, and inconsistent modules (for example, batch normalization layer BN) are repaired.

For example, it is assumed that the pre-pruning model and the post-pruning model are respectively as follows:
(1) pre-pruning model: the image with dimension h*w*1 is passed through the first one of the convolution layers (conv1 with a convolution kernel: 3*3*1*c1) to output a feature map f1 with dimension h*w*c1, and f1 is passed through the second one of the convolution layers (conv2 with convolution kernel: 3*3*c1*c2) to output the feature map with dimension h*w*c2;
(2) pre-pruning model: the image with dimension h*w*1 is passed through the first one of the convolution layers (conv1′ with a convolution kernel: 3*3*1*c1′) to output a feature map f1′ with dimension h*w*c1, and f1′ is passed through the second one of the convolution layers (conv2′ with convolution kernel: 3*3*c1′*c2′) to output the feature map with dimension h*w*c2′;
c1′ and c2′ are obtained by multiplying c1 and c2 by pruning coefficient respectively and being rounded, and c1′ is obtained by the dependency relationship between conv1 and conv2 (the number of output channels of current convolution layer c1′=the number of input channels of next convolution layer c1′).

The channel alignment in the embodiment of the present disclosure mainly refers to a process in which the number of channels in each convolution kernel dimension in the latter convolution layer conv2 is adaptively adjusted according to the pruning result of the previous convolution layer conv1. The image of the pre-pruning model outputs a dimension h*w*c1 after passing through the previous convolution layer conv1, in which c1 channel is obtained by convolution of the 3*3*1 convolution kernels with a quantity of c1 in conv1 and the input image respectively. When the number of convolution kernels in conv1 of the previous convolution layer is compressed to c1′ by channel pruning, the output feature map dimension of conv1 of the previous convolution layer is correspondingly adjusted to h*w*c1′, and the number of channels of each convolution kernel in conv2 of the latter convolution layer also needs to be adjusted from c1 to c1′ (which channels are specifically deleted in the adjustment process should be corresponded with the convolution kernel retained after pruning and clipping of conv1 channel).

The training method according to an embodiment of the present disclosure can also improve the recognition accuracy of the model by slight-adjustment and knowledge distillation to the post-pruning model.

In some exemplary embodiments, the training method further includes:
the trained training model is regarded as a teacher model and the pruned training model is regarded as a student model;
a mean square error loss function between the teacher model and the student model is constructed, and a cross entropy loss function between the predicted characters of the student model and the hard labels is constructed;
based on the constructed mean square error loss function and cross entropy loss function, the teacher model is used to train the student model.

Since the recognition accuracy of the handwriting recognition model after channel pruning is lower than that of the original trained handwriting recognition mode before pruning, the embodiment of the present disclosure adopts the knowledge distillation—a Logits distillation (a knowledge distillation mode) for the small post-pruning model by using the original large model, thereby improving the recognition accuracy of the small post-pruning model. The implementation process is shown in FIG. 8 (ResNet_tiny in the figure represents the feature extraction network after channel pruning, Squeeze Model represents the height compression module, and the Classifier includes FC layer and Softmax layer). The original trained handwriting recognition model is used as a Teacher model, and the small model obtained after channel pruning is used as a Student model. The distillation network is divided into two parts, and one part still adopts the original loss calculation manner for the handwriting recognition model—the input image is passed through the Softmax layer of Student model to output the probability values of different characters, and the output probability values and hard labels are used to calculate the Cross Entropy Loss function (so that the probability value of positive labels approaches 1, the probability value of negative labels approaches 0, and all negative labels are treated uniformly), that is, CTC Loss in FIG. 8; the other part calculates the mean square error loss (MSE Loss) of the output probability values of Softmax layer of Teacher model and Student model, so that the output probability value of Student model approximates the output probability value of Teacher model, and directly calculates the loss function of the probability values of the two models, which can make full use of the information contained in negative labels. For example, in certain input image, “2” is more similar to “3”, and the corresponding probability of “3” in the output value of the Softmax layer of the model is obviously higher than that of other negative labels, while in another image, “2” is more similar to “7”, and the corresponding probability of “7” in the output value of the Softmax layer of the model is higher. The hard targets of these two “2” are the same, but the soft targets are different. The soft target contains more information than the hard target, and when the entropy of soft target distribution is relatively high, its soft target contains even more knowledge.

The output values of input image passed through the Softmax layer of Teacher model are used as soft labels, and the output values of input image passed through Softmax layer of Student model are soft predictions. The soft labels and soft predictions are used to calculate MES loss. MSE Loss and CTC Loss are weighted and summed as the final Loss of the training process.

The comparison effects of Params, Flops and recognition accuracy (character accuracy) of the model before and after light weighted are shown in Table 2.

TABLE 2

| | | | Character |
|---|---|---|---|
| | Params (M) | Flops (G) | accuracy (%) |
| Baseline (pre-lightweight | 13.37 | 3.53 | 97.7 |
| model) | | | |
| Baseline_prune_distil | 1.8 | 1.09 | 97.19 |
| (post-lightweight model) | | | |

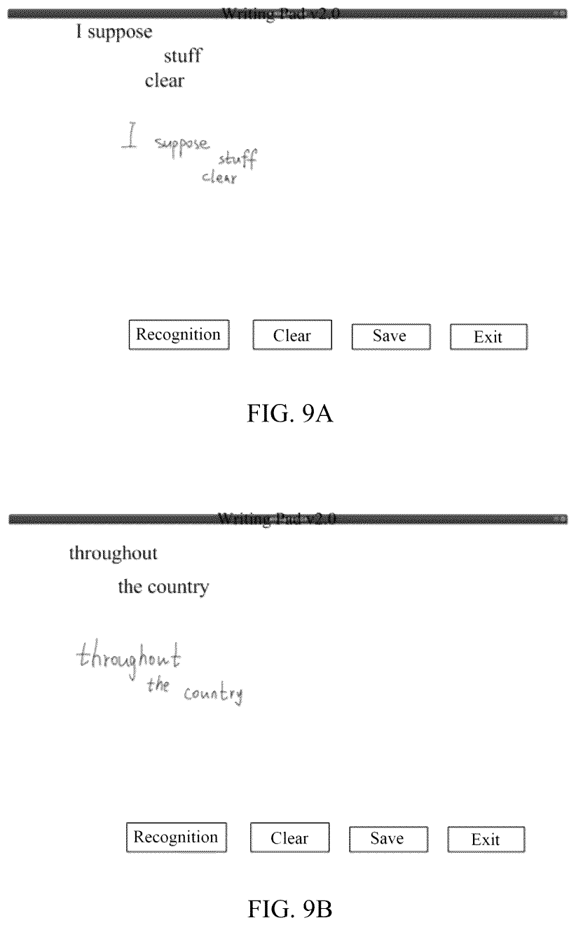

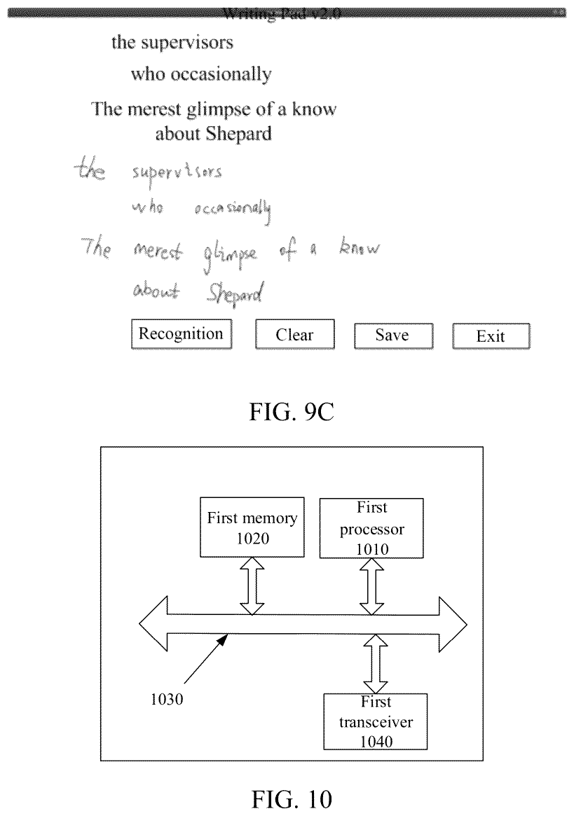

By the training method according to an embodiment of the present disclosure, compared with the original model (Baseline), the parameter quantity is compressed from 13.37M to 3.53M and reduces the calculation quantity from 3.53 G to 1.09 G under the premise that the recognition accuracy is not obviously reduced. Three exemplary recognition results are shown in FIGS. 9A, 9B, and 9C.

The handwriting recognition method according to the embodiment of the disclosure designs an end-to-end full-text handwriting recognition network, adopts an image feature extraction layer to extract input image features, and performs a global classification thereof to realize full-text recognition, thus improving the problem that the recognition effect in the related method is limited by the detection performance of a detector, and the network structure is simple.

The training method of the handwriting recognition model according to an embodiment of the disclosure adopts a sample text image whose height is fixed as pixels with a quantity of a in the training process, and in order to ensure that the height of the text sent into the network is basically controlled at pixels with a quantity of a during multi-line text recognition, a method for adaptively determining the height of the input image is designed. In order to reduce the difference between samples caused by different font sizes and make the training process converge quickly, the trace point mapping is used in the pre-processing stage to convert trace points into images with target height, so as to ensure that the font line width sent into the network is consistent. In addition, aiming at some letter recognition errors caused by joined-up writing and scrawls in the writing process, an automatic word correction algorithm based on dynamic programming is added in the network post-processing stage, and a corpus is established to secondarily correct the recognition result to improve the recognition accuracy. Aiming at the problems of large parameter quantity and large calculation quantity of the recognition network, the training method according to an embodiment of the present disclosure adopts a method combining channel pruning and Logits distillation to lightweight the handwriting recognition model, so that the parameter quantity and calculation quantity are reduced under the premise of almost not losing accuracy, which facilitates the off-line deployment of the terminal.

An embodiment of the present disclosure further provides a handwriting recognition device, including a memory and a processor connected to the memory, the memory is configured to store instructions, the processor is configured to perform steps of a handwriting recognition method according to any embodiment of the present disclosure based on the instructions stored in the memory.

In an example, as shown in FIG. 10, the handwriting recognition device may include: a first processor 1010, a first memory 1020, a first bus system 1030 and a first transceiver 1040. The first processor 1010, the first memory 1020 and the first transceiver 1040 are connected through the first bus system 1030, the first memory 1020 is used to store instructions, and the first processor 1010 is used to execute the instructions stored in the first memory 1020 to control the first transceiver 1040 to send and receive signals. Specifically, the first transceiver 1040 may, under the control of the first processor 1010, obtain a written text trace to be recognized from the text input interface, the first processor 1010 determines an input text image based on the written text trace to be recognized; the input text image is input into the handwriting recognition model to obtain the prediction result of respective spatial position. The handwriting recognition model includes an image feature extraction layer, a full connection layer and a Softmax layer, wherein, the image feature extraction layer is used for extracting a feature map of the input text image, the full connection layer is used for adjusting the number of the channel of the feature map to the number of characters supported by the handwriting recognition model, and the Softmax layer is used for obtaining the prediction probability value of the written text at different spatial positions; a multi-neighborhood merging is performed on the prediction result of each spatial position to obtain a recognition result, and the obtained recognition result is output to the text input interface through the first transceiver 1040.

It should be understood that the first processor 1010 may be a Central Processing Unit (CPU), or the first processor 1010 may be another general-purpose processor, a digital signal processor (DSP), an application specific integrated circuit (ASIC), a field programmable gate array (FPGA), or another programmable logic device, a discrete gate or a transistor logic device, a discrete hardware component, etc. The general-purpose processor may be a microprocessor, or the processor may be any conventional processor, etc.

The first memory 1020 may include a read only memory and a random access memory, and provides instructions and data to the first processor 1010. A portion of the first memory 1020 may also include a non-volatile random access memory. For example, the first memory 1020 may also store information of a device type.

The first bus system 1030 may include a power bus, a control bus, a status signal bus, or the like in addition to a data bus. However, for the sake of clarity, various buses are all labeled as the first bus system 1030 in FIG. 10.

In an implementation process, processing performed by a processing device may be completed through an integrated logic circuit of hardware in the first processor 1010 or instructions in a form of software. That is, the steps of the method in the embodiments of the present disclosure may be embodied as executed and completed by a hardware processor, or executed and completed by a combination of hardware in the processor and a software module. The software module may be located in a storage medium such as a random access memory, a flash memory, a read only memory, a programmable read-only memory, or an electrically erasable programmable memory, or a register, etc. The storage medium is located in the first memory 1020, and the first processor 1010 reads information in the first memory 1020 and completes the steps of the foregoing methods in combination with its hardware. In order to avoid repetition, detailed description is not provided herein.

An embodiment of the present disclosure also provides a computer readable storage medium on which a computer program is stored, and when the program is executed by the processor, the handwriting recognition method according to any embodiment of the present disclosure is realized. A method of driving prognosis analysis by executing executable instructions is substantially the same as the handwriting recognition method provided in the above embodiments of the present disclosure and will not be repeated here.

In some possible embodiments, the various aspects of the handwriting recognition method provided herein may also be implemented in the form of a program product, which includes a program code. When the program product is run on a computer device, the program code is used to enable the computer device to perform the steps in the handwriting recognition method described above in this specification according to various exemplary embodiments of the present application, for example, the computer device may perform the handwriting recognition method described in embodiments of the present application.

For the program product, any combination of one or more readable media may be adopted. A readable medium may be a readable signal medium or a readable storage medium. The readable medium may be a readable signal medium or a readable storage medium. The readable storage medium may be, for example, but not limited to, an electrical, magnetic, optical, electromagnetic, infrared, or semiconductor system, apparatus or device, or a combination of any of the above. More specific examples (non-exhaustive list) of the readable storage medium include electrical connections with one or more wires, portable computer disks, hard disks, random access memories (RAM), read-only memories (ROM), erasable programmable read-only memories (EPROM or flash memories), optical fibers, portable compact disk read-only memories (CD-ROM), optical storage devices, magnetic storage devices, or any suitable combination of the above.

An embodiment of the present disclosure also provides a training device of a handwriting recognition model, including a memory and a processor connected to the memory, wherein the memory is configured to store instructions, the processor is configured to execute steps of the training method of the handwriting recognition model according to any embodiment of the present disclosure based on the instructions stored in the memory.

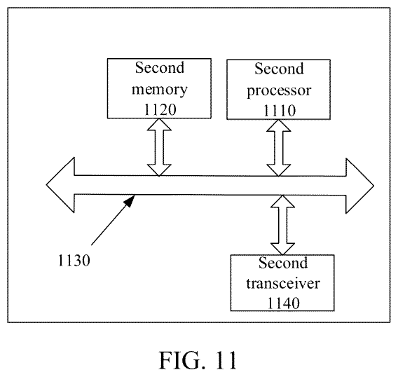

In an example, as shown in FIG. 11, a training device of the handwriting recognition model may include: a second processor 1110, a second memory 1120, a second bus system 1130, and a second transceiver 1140, wherein the second processor 1110, the second memory 1120, and the transceiver 1140 are connected through the second bus system 1130, the second memory 1120 is configured to store instructions, and the second processor 1110 is configured to execute the instructions stored in the second memory 1120 to control the second transceiver 1140 to send and receive signals. Specifically, the second transceiver 1140 can obtain a plurality of sample text images under the control of the second processor 1110, wherein the number of lines of written text in the sample text image is one, and the height of the sample text image is pixels with a quantity of a, and a is a natural number greater than or equal to 1. The second processor 1110 constructs a training model of the handwriting recognition model, the handwriting recognition model includes an image feature extraction layer, a full connection layer and a Softmax layer, the training model includes the handwriting recognition model and a height compression module, wherein, the image feature extraction layer is used for extracting a feature map of the input text image, the full connection layer is used for adjusting the number of the channels of the feature map to the number of characters supported by the handwriting recognition model, and the Softmax layer is used for obtaining the prediction probability value of the written text at different spatial positions, the height compression module is disposed between the image feature extraction layer and the full connection layer and used for compressing the height of the feature map extracted by the image feature extraction layer. According to the predefined loss function, the training model is trained by adopting a plurality of sample text images. The height compression module in the trained training model is removed to obtain the trained handwriting recognition model.

It should be understood that the second processor 1110 may be a Central Processing Unit (CPU), or the second processor 1110 may be another general-purpose processor, a digital signal processor (DSP), an application specific integrated circuit (ASIC), a field programmable gate array (FPGA), or another programmable logic device, a discrete gate or a transistor logic device, a discrete hardware component, etc. The general-purpose processor may be a microprocessor, or the processor may be any conventional processor, etc.

The second memory 1120 may include a read only memory and a random access memory, and provides instructions and data to the second processor 1110. A portion of the second memory 1120 may also include a non-volatile random access memory. For example, the second memory 1120 may also store information of a device type.

The second bus system 1130 may include a power bus, a control bus, a status signal bus, or the like in addition to a data bus. However, for the sake of clarity, various buses are all labeled as the second bus system 1130 in FIG. 11.

In an implementation process, processing performed by a processing device may be completed through an integrated logic circuit of hardware in the second processor 1110 or instructions in a form of software. That is, the steps of the method in the embodiments of the present disclosure may be embodied as executed and completed by a hardware processor, or executed and completed by a combination of hardware in the processor and a software module. The software module may be located in a storage medium such as a random access memory, a flash memory, a read only memory, a programmable read-only memory, or an electrically erasable programmable memory, or a register, etc. The storage medium is located in the second memory 1120, and the second processor 1110 reads information in the second memory 1120 and completes the steps of the foregoing methods in combination with its hardware. In order to avoid repetition, detailed description is not provided herein.

An embodiment of the present disclosure also provides a computer-readable storage medium having stored thereon a computer program, when the program is executed by a processor, the training method of the handwriting recognition model according to any embodiment of the present disclosure is implemented.

In some possible implementation modes, various aspects of the training method of the handwriting recognition model according to the present application may also be implemented in a form of a program product, which includes a program code. When the program product is run on a computer device, the program code is used for enabling the computer device to execute steps in the training method of the handwriting recognition model according to various exemplary implementation modes of the present application described above in this specification, for example, the computer device may execute the training method of the handwriting recognition model described in the embodiments of the present application.

For the program product, any combination of one or more readable media may be adopted. A readable medium may be a readable signal medium or a readable storage medium. The readable medium may be a readable signal medium or a readable storage medium. The readable storage medium may be, for example, but not limited to, an electrical, magnetic, optical, electromagnetic, infrared, or semiconductor system, apparatus or device, or a combination of any of the above. More specific examples (non-exhaustive list) of the readable storage medium include electrical connections with one or more wires, portable computer disks, hard disks, random access memories (RAM), read-only memories (ROM), erasable programmable read-only memories (EPROM or flash memories), optical fibers, portable compact disk read-only memories (CD-ROM), optical storage devices, magnetic storage devices, or any suitable combination of the above.

It may be understood by those of ordinary skills in the art that all or some steps in a method and function modules/units in a system and an apparatus disclosed above may be implemented as software, firmware, hardware, and appropriate combinations thereof. In a hardware implementation, division of the function modules/units mentioned in the above description is not always corresponding to division of physical components. For example, a physical component may have multiple functions, or a function or an act may be executed by several physical components in cooperation. Some components or all components may be implemented as software executed by a processor such as a digital signal processor or a microprocessor, or implemented as hardware, or implemented as an integrated circuit such as an application specific integrated circuit. Such software may be distributed in a computer-readable medium, and the computer-readable medium may include a computer storage medium (or a non-transitory medium) and a communication medium (or a transitory medium). As known to those of ordinary skills in the art, the term computer storage medium includes volatile and nonvolatile, and removable and irremovable media implemented in any method or technology for storing information (for example, a computer-readable instruction, a data structure, a program module, or other data). The computer storage medium includes, but not limited to, RAM, ROM, EEPROM, a flash memory or another memory technology, CD-ROM, a digital versatile disk (DVD) or another optical disk storage, a magnetic cassette, a magnetic tape, a magnetic disk storage, or another magnetic storage apparatus, or any other medium that may be configured to store desired information and may be accessed by a computer. In addition, it is known to those of ordinary skills in the art that the communication medium usually includes a computer-readable instruction, a data structure, a program module, or other data in a modulated data signal of, such as, a carrier or another transmission mechanism, and may include any information delivery medium.

Although the implementations disclosed in the present disclosure are described as above, the described contents are only implementations which are used for facilitating the understanding of the present disclosure, but are not intended to limit the present invention. Any skilled person in the art to which the present disclosure pertains may make any modifications and variations in forms and details of implementations without departing from the spirit and scope of the present disclosure. However, the patent protection scope of the present invention should be subject to the scope defined by the appended claims.

1. A handwriting recognition method, comprising:
determining an input text image according to a written text trace to be recognized;
inputting the input text image into a handwriting recognition model to obtain prediction results of different spatial positions in the input text image, wherein the handwriting recognition model comprises an image feature extraction layer, a full connection layer and a Softmax layer, the image feature extraction layer is configured to extract a feature map of the input text image, the full connection layer is configured to adjust a channel number of the feature map to a quantity of characters supported by the handwriting recognition model, and the Softmax layer is configured to obtain prediction probability values of a written text at the different spatial positions, each spatial position comprises a width of at least one pixel*a height of at least one pixel; and
performing multi-neighborhood merging on the prediction results of the different spatial positions to obtain a recognition result.

2. The handwriting recognition method according to claim 1, further comprising: training the handwriting recognition model through the following process:
constructing a training model of the handwriting recognition model, wherein the training model comprises the handwriting recognition model and a height compression module, the height compression module is disposed between the image feature extraction layer and the full connection layer, and is configured to compress a height of the feature map extracted by the image feature extraction layer;
acquiring a plurality of sample text images, wherein a number of lines of written text in a sample text image is 1 line, and a height of the sample text image is a pixel, and a is a natural number greater than or equal to 1;
training the training model by using the plurality of sample text images according to a predefined loss function; and
removing the height compression module in the trained training model to obtain a trained handwriting recognition model.

3. The handwriting recognition method according to claim 2, wherein the height compression module comprises a second convolution layer, a batch normalization layer, an activation function layer, a weight calculation layer and a height compression layer,
wherein the second convolution layer is configured to extract features of the feature map extracted by the image feature extraction layer;
the batch normalization layer is configured to normalize the features extracted by the second convolution layer;
the activation function layer is configured to increase nonlinearity of the height compression module;
the weight calculation layer is configured to calculate a weight value of each pixel in all pixels with a same width value;
the height compression layer is configured to multiply each column of the feature map of the input text image in a height direction and a corresponding position of the corresponding column of the weight value in the height direction and sum the products up to obtain a feature map after height compression; or
wherein the predefined loss function comprises a connectionist temporal classification (CTC) loss function.

4. (canceled)

5. The handwriting recognition method according to claim 3, wherein the predefined loss function further comprises an auxiliary loss function Lₛᵤₚ,
$${L}_{sup} = \frac{1}{K} {\sum }_{k = 1}^{K} \vert {h}_{k} {y}_{k} \vert ,$$
K is a total number of characters predicted by the training model, yₖ is a probability score of a k-th character predicted by the training model,
$${h}_{k} = \{ \begin{matrix}0 , & k ∈ in\_label \\ 1 , & k ∈ out\_label\end{matrix} ,$$
k∈in_label represents that the predicted characters are the same as the hard labels, k∈out_label represents that the predicted characters are different from the hard labels.

6. The handwriting recognition method according to claim 1, wherein determining the input text image based on the written text trace to be recognized comprises:
acquiring the written text trace to be recognized to determine an equivalent number of lines of the written text; and
calculating a height of the input text image according to the equivalent number of lines of the written text, and determining the input text image according to the height of the input text image.

7. The handwriting recognition method according to claim 6, wherein calculating the height of the input text image based on an equivalent number of lines of the written text comprises:
the height of the input text image input_h=[raw_numxa], where raw_num is the equivalent number of lines of the written text, a is a height of a sample text image used in training the handwriting recognition model, [ ] is a rounding symbol, a is a natural number greater than or equal to 1, and the number of lines of the written text in the sample text image is 1; or
wherein the written text comprises at least one character, each of the characters comprises at least one stroke, and determining the equivalent number of lines of the written text comprises:
determining a height trace_sl_h of a single-line text in the written text trace to be recognized;
calculating a height trace_h of the written text, where trace_h=(Ymax−Ymin+1), Ymin is a minimum value of Y-axis coordinates of all strokes, and Ymin is a maximum value of Y-axis coordinates of all strokes; and
determining the equivalent number of lines of the written text raw_num, where raw_num=trace_h/trace_sl_h.

8. (canceled)

9. The handwriting recognition method according to claim 7, wherein each of the strokes comprises at least one trace point, and determining the input text image according to the height of the input text image comprises:
calculating a scaled factor ratio between the input text image and the written text trace to be recognized, wherein ratio=input_h/trace_h, where input_h is the height of the input text image and trace_h is the height of the written text; and
determining coordinates of trace points in the input text image, wherein point_X=(point_X−xmin)×ratio, point_Y=(point_Y−ymin)×ratio, point_X and point_Y represent X-axis coordinates and Y-axis coordinates of the trace points in the written text trace to be recognized, respectively, xmin and ymin represent a minimum value of X-axis coordinates and a minimum value of the Y-axis coordinates of all the trace points in the written text trace to be recognized, respectively, and point_X and point_Y represent X-axis coordinates and Y-axis coordinates of the trace points in the input text image, respectively.

10. The handwriting recognition method according to claim 1, wherein after performing the multi-neighborhood merging on the prediction results of the different spatial positions, the method further comprises:
performing same-line alignment on the prediction results of the different spatial positions; and
wherein performing the same-line alignment on the prediction results of the different spatial positions comprises:
calculating an average value avg_x of X axis coordinates of all pixels and an average value avg_y of Y axis coordinates of all pixels in each connected domain after the multi-neighborhood merging; and
traversing each connected domain in sequence according to avg_x from small to large, and aligning pixels with a difference in avg_y being less than or equal to c, where c is less than or equal to a width of 5 pixels.

11. (canceled)

12. The handwriting recognition method according to claim 1, wherein further comprising:
automatically correcting English words in the recognition result according to a pre-established corpus.

13. The handwriting recognition method according to claim 12, wherein automatically correcting the English words in the recognition result according to the pre-established corpus comprises:
detecting whether the English words in the recognition result are English words in the corpus or not;
when the recognition result comprises one or more English words that are not the English words in the corpus, marking the one or more English words as words to be corrected, and a minimum edit distance from each of the words to be corrected to the English words in the corpus is calculated; and
correcting each of the words to be corrected according to the calculated minimum edit distance.

14. The handwriting recognition method according to claim 13, wherein correcting each of the words to be corrected according to the calculated minimum edit distance comprises:
initializing a current detection value of the minimum edit distance to 1;
detecting whether a first English word exists and the number of the first English words, wherein a minimum edit distance between the first English word and a word to be corrected is the current detection value of the minimum edit distance;
correcting the word to be corrected as the first English word when the first English word exists and the number of the first English word is 1;
when the first English words exist and the number of the number of the first English words is two or more, sorting the two or more first English words according to the occurrence times in the corpus to obtain a first English word with the most occurrence times in the corpus, and correcting the word to be corrected as the first English word with the most occurrence times in the corpus; and
self-increasing the current detection value of the minimum edit distance by 1 when the first English word does not exist, and returning to the step of detecting whether the first English word exists and the number of the first English word to perform cyclic detection until the current detection value of the minimum edit distance is greater than a predefined threshold value of the minimum edit distance and stopping the detection; or
wherein calculating the minimum edit distance from each of the words to be corrected to the English words in the corpus comprises:
constructing a state transition matrix according to the following formula, and recursively calculating from D[1,1] to D[M, N]:
$$D [ i , j ] = min \{ \begin{matrix}D [ i - 1 , j ] + del\_cost \\ D [ i , j - 1 ] + ins\_cost \\ D [ i - 1 , j - 1 ] + \{ \begin{matrix}rep\_cost , src [ i ] \neq tar [ j ] \\ 0 , src [ i ] = tar [ j ]\end{matrix}\end{matrix} ;$$
wherein D[i, j] represents a minimum edit distance from an i-th element of the word to be corrected to a j-th element of a target English word, the target English word is an English word in the corpus; a letter number of the word to be corrected is M, a letter number of the target English word is N, i is a natural number between 0 and M, j is a natural number between 0 and N, M and N are both natural numbers greater than or equal to 1, del_cost is a deletion cost, and when a character needs to be deleted, del_cost=1; ins_cost is a insertion cost, and when a character needs to be inserted, ins_cost=1; rep_cost is a replacement cost, and when a character needs to be replaced, rep_cost=1; and
taking D[M, N] as the minimum edit distance from the word to be corrected to the target English word.

15. (canceled)

16. A handwriting recognition device, comprising a memory and a processor connected to the memory, wherein the memory is configured to store instructions, the processor is configured to perform the steps of the handwriting recognition method according to claim 1 based on the instructions stored in the memory.

17. A computer-readable storage medium, on which a computer program is stored, wherein when the program is executed by a processor, the handwriting recognition method according to claim 1 is implemented.

18. A training method of a handwriting recognition model, comprising:
constructing a training model of the handwriting recognition model, wherein the handwriting recognition model comprises an image feature extraction layer, a full connection layer and a Softmax layer, the training model comprises the handwriting recognition model and a height compression module, wherein the image feature extraction layer is configured to extract a feature map of the input text image, the full connection layer is configured to adjust a channel number of the feature map to a quantity of characters supported by the handwriting recognition model, the Softmax layer is configured to obtain prediction probability values of the written text at different spatial positions, and the height compression module is disposed between the image feature extraction layer and the full connection layer for compressing a height of the feature map extracted by the image feature extraction layer;
acquiring a plurality of sample text images, wherein a number of lines of written text in a sample text image is 1 line, and a height of the sample text image is a pixel, and a is a natural number greater than or equal to 1;
training the training model by using the plurality of sample text images according to a predefined loss function; and
removing the height compression module in the trained training model to obtain a trained handwriting recognition model.

19. The training method according to claim 18, wherein the height compression module comprises a second convolution layer, a batch normalization layer, an activation function layer, a weight calculation layer and a height compression layer
wherein the second convolution layer is configured to extract features of the feature map extracted by the image feature extraction layer;
the batch normalization layer is configured to normalize the features extracted by the second convolution layer;
the activation function layer is configured to increase nonlinearity of the height compression module;
the weight calculation layer is configured to calculate a weight value of each pixel in all pixels with a same width value; and
the height compression layer is configured to multiply each column of the feature map of the input text image in a height direction and a corresponding position of the corresponding column of the weight value in the height direction and sum the products up to obtain a feature map after height compression.

20. The training method according to claim 18, wherein the predefined loss function comprises a CTC loss function; or
wherein the image feature extraction layer comprises a plurality of first convolution layers, the method further comprises:
determining a channel pruning ratio of each first convolution layer in the trained training model;
acquiring a channel to be deleted for each first convolution layer;
constructing a dependency graph, wherein the dependency graph comprises a dependence relationship among the plurality of first convolution lavers; and
performing a pruning operation on the channel to be pruned and aligning the channel according to the dependency relationship.

21. The training method according to claim 20, wherein the predefined loss function comprises an auxiliary loss function Lₛᵤₚ,
$${L}_{sup} = \frac{1}{K} {\sum }_{k = 1}^{K} \vert {h}_{k} {y}_{k} \vert ,$$
K is a total number of characters predicted by the training model, yₖ is a probability score of a k-th character predicted by the training model,
$${h}_{k} = \{ \begin{matrix}0 , & k ∈ in\_label \\ 1 , & k ∈ out\_label\end{matrix} ,$$
k∈in_label represents that the predicted characters are the same as hard labels, k∈out_label represents that the predicted characters are different from the hard labels.

22. (canceled)

23. The training method according to claim 18, wherein further comprising:
taking the trained training model as a teacher model and taking the pruned training model as a student model;
constructing a mean square error loss function between the teacher model and the student model, and constructing a cross entropy loss function between predicted characters of the student model and the hard labels; and
training the student model the teacher model is used to based on the constructed mean square error loss function and cross entropy loss function.

24. A training device of a handwriting recognition model, comprising a memory and a processor connected to the memory, wherein the memory is configured to store instructions, the processor is configured to perform the steps of the training method of the handwriting recognition model according to claim 1 based on the instructions stored in the memory.

25. A computer-readable storage medium, on which a computer program is stored, wherein when the program is executed by a processor, the training method of the handwriting recognition model according to claim 1 is implemented.
